(19) United States
(12) Patent Application Publication
(10) Pub. No.: US 2007/0065546 A1
(43) Pub. Date: Mar. 22, 2007

(54) Controlled atmosphere in a container

(76) Inventors: Gert Jorgensen, Aabenraa (DK); Richard D. Schmidt, Grasten (DK)

Correspondence Address: BRINKS HOFER GILSON & LIONE, P.O. BOX 10395, CHICAGO, IL, 60610, US

(21) Appl. No.: 11/233,206

(22) Filed: Sep. 22, 2005

(51) Int. Cl. A23B 4/16

(52) U.S. Cl. 426/316

(57) ABSTRACT

The invention relates to an apparatus for controlling the composition of gases within a cargo container. The apparatus includes at least one sensor, at least one controller and at least one gas permeable membrane being adapted to facilitate the passage there through of different parts of gasses at different rates. A first region and a second region, the first region being for holding cargo and the second region defining a gas buffer region, said at least one inlet and/or outlet being in communication with said buffer region, said membrane being adapted to allow oxygen and carbon dioxide to flow through it, provided that the direction of the flow of oxygen is opposite that of the carbon dioxide, wherein the membrane has a permeability for carbon dioxide, which is at least eight times higher than the permeability for oxygen. The invention further relates to a method.

### TECHNICAL FIELD

The invention relates to an apparatus for controlling the composition of gases. Preferably the present invention may be adapted to provide an apparatus for a container where such an apparatus is preferably adapted to control the composition of gases within a container. Reference throughout this specification will be made to the present invention being used to control the composition of gases within containers, but those skilled in the art should appreciate that other applications are also envisioned for the present invention.

The invention further relates to a method for controlling the composition of gases.

### BACKGROUND ART

The use of shipping or transportation containers is well known for the transport of products and commodities over long distances. To extend or otherwise preserve the shelf life of such transportable products the shipping containers are normally equipped with some form of temperature regulation system, such as a refrigeration system.

Instances in which the products to be transported are perishable goods, such as fruit and/or vegetables, transport containers may also incorporate a system adapted to modify the composition of the refrigerated air surrounding the stored contents. As fresh fruit and vegetables represent active biological systems the atmosphere of a container will constantly change as gases and moisture are produced by the metabolic processes (such as respiration) occurring within the biological systems present. Furthermore, the shelf life of a lot of shipped produce is highly dependent on the composition of gases within a container where the optimal gaseous composition of a storage container is highly dependent on the specific produce being stored.

By incorporating an atmospheric modification or control system into a transport container the respiration rates of the stored produce and the gases present within a container may be regulated, thereby providing an effective means for prolonging the shelf life of the container contents in addition to the refrigeration of the air. In particular, the respiration rates of stored produce may be retarded by controlling the mix and/or volumes of oxygen, carbon dioxide and nitrogen within the container.

Furthermore, a container may provide an environment suitable for the growth of spoilage microorganisms and the proliferation of insects and other pests. To counter such activity systems normally rely on the use of chemicals to eliminate pathogen and insect damage to stored produce. The use of atmosphere control systems adapted to control respiration may also inhibit pathogen production and kill insects, and therefore contribute to a reduction in the number and quantity of chemicals, being applied to reduce or eliminate such damage to stored produce. For example, trials have demonstrated that the greatest impact on insect proliferation within a container may be achieved by maintaining reduced levels of oxygen for extended periods of time, which leads to oxygen deprivation in insect body tissue.

A common approach used in shipping containers to increase the shelf life of produce stored is to create an “ideal” or optimum storage atmosphere (that is different from that of ambient air) at the beginning of the storage period and to maintain that atmosphere. In some cases containers are initially flushed to remove or add gases resulting in an internal gas composition around the stored produce that is different from that of ambient air. Once the oxygen content of the gases within a container drops further as a result of respiration, inlets may be opened to allow fresh air into the container, thereby delivering oxygen into the container. Such systems often rely on the use of membranes or films which are adapted to prevent the movement of gases into or out of the container, and such systems are commonly referred to as Modified Atmosphere (MA) systems.

However, by ventilating the container with fresh air and letting out the container air, the composition of the gas in the container will over time eventually result in a gas composition in which the carbon dioxide and oxygen content (as a sum proportion of container gases) approaches approximately 21%. Such a proportion of carbon dioxide and oxygen is not necessarily an optimal environment for the storage of certain products. If the container is not initially flushed, the sum of oxygen and carbon dioxide will always remain approximately 21%.

Although such systems may be relatively inexpensive to integrate into a container they are not well suited to adequately control and maintain optimum levels of carbon dioxide within a container, where such optimum levels often differ from those levels of carbon dioxide present in ambient air.

Moreover, the sum proportion of carbon dioxide and oxygen in a container will always remain approximately 21% unless the composition of either the outgoing and/or ingoing air is actively and effectively manipulated to thereby change this sum proportion (of 21%) as necessary. Other methods, for example the use of carbon dioxide absorbent lime, can be used to actively and selectively remove gases from the cargo space of a container. However, such methods have disadvantages including the disposal of used lime and ineffective control.

An alternative approach is to provide a container having concentrations of oxygen and/or carbon dioxide that are different from that of ambient air and regularly measuring and actively maintaining those concentrations during a storage period. In particular, such systems will typically maintain low levels of oxygen and higher levels of carbon dioxide (compared to ambient air) so that the levels of respiration occurring within stored produce may be controlled. To effectively gauge the concentrations and/or volumes of oxygen and other gases within a container such a system may often utilize sensor technology which is located within a container and is adapted to actively assess the gaseous composition inside a container. These systems are commonly referred to as Controlled Atmosphere (CA) systems.

Such Controlled Atmosphere (CA) systems are adapted to ensure that the appropriate remedial action is taken to ensure that the gaseous composition of a container is maintained, or returned to an optimal level when deviation occurs. To ensure optimal levels of gases are maintained (usually this involves reduced oxygen levels and increased carbon dioxide levels) many Controlled Atmosphere (CA) systems are provided with a filter adapted to compress and separate the components of incoming air. In this way, as air is directed into a container, excess oxygen may be prevented from entering the container, which is desirable as it will ensure the retardation of respiratory activity within the container.

Use of Controlled Atmosphere (CA) systems will enable a container to maintain the optimal gas composition specifically suited to the produce and/or goods contained within where such a gas composition may be actively controlled throughout the period of storage.

Whilst such a system may effectively control and maintain optimal conditions that will contribute to longevity of stored produce such systems are extremely expensive to manufacture and maintain. Moreover, these systems tend to be very complicated and typically demand the services of a skilled and specialized work force to ensure they are adequately maintained.

The provision of an improved control system which can actively monitor the composition of gases in a container and provide an optimal environment for the storage of container contents would be of advantage.

The provision of a system able to effectively control the flow of gases into and/or out of a container to thereby promote a gaseous atmosphere in a container which will prolong the shelf life of stored produce would be of advantage. The provision of such a system which is both relatively inexpensive to produce and maintain would be advantageous.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Such an apparatus for controlling the atmosphere in a container is described in international patent application no. WO 2004/107868, disclosing a container including a plurality of walls, and at least one inlet and/or outlet. Within the container is an apparatus including a sensor, a controller and a gas permeable membrane being adapted to facilitate the passage there through of different parts of gases at different rates. The membrane is separating the apparatus into a first region and a second region, the first region being for holding cargo and the second region defining a gas buffer region, where at least one inlet and/or outlet are in communication with the buffer region.

In another embodiment the at least one inlet and/or outlet is adapted to be able to bring the cargo region and the buffer region in mutual communication.

The problem to be solved is to achieve an atmosphere in a cargo region, where a membrane is able to obtain and control a low concentration of carbon dioxide and of oxygen in the atmosphere in the cargo region.

An embodiment of an apparatus to solve that problem can be the use of a membrane with a high selectivity, why also a use of several membranes with varying selectivity, each membrane having a specific selectivity to the different stages of concentration and composition of gases during the storing period is a solution to obtain the above atmosphere, albeit not the most adequate solution.

It is not convenient to depend upon the use of several membranes; therefore it is the aim of the invention to produce a membrane with a selectivity and permeability that can handle a change in the composition of atmosphere going from approximately 21% oxygen to approximately 0% oxygen and 0% carbon dioxide to 21% carbon dioxide. It is the aim to provide a membrane capable of ensuring a flux high enough to match the carbon dioxide “production” from the high respiration rate of the commodity when the process is started. As the concentration of oxygen decreases in the cargo region and the respiration rate decreases as well as a consequence hereof, it is the aim of the invention that the membrane has a selectivity high enough to ensure a flux ratio of carbon dioxide/oxygen greater than one through the membrane at any time during the decrease of oxygen and the increase of carbon dioxide in the cargo zone at any final setpoint for example 2% oxygen and 2% carbon dioxide, 2% oxygen and 1% carbon dioxide, 1% oxygen and 1% carbon dioxide, 1% oxygen and approximately 0% carbon dioxide or approximately 0% oxygen and carbon dioxide.

When the process has started and the apparatus has obtained a kind of equilibrium, the content of carbon dioxide and oxygen should be in ranges from greater than 0 to 12-13% of the atmosphere.

It is an object of the present invention to address at least some of the foregoing problems or at least to provide the public with a useful choice.

Further aspects and advantages of the present invention will become apparent from the ensuing description which is given by way of example only.

### DISCLOSURE OF INVENTION

According to one aspect of the present invention it is the aim to provide an apparatus for controlling the composition of gases within a container.

This is achieved by using a membrane having permeability for carbon dioxide which is at least eight times higher than the permeability for oxygen.

A membrane may be defined as a thin barrier and such a permeable membrane is adapted to facilitate the transportation of different molecular species or parts of gases through the barrier (membrane) at different rates. Furthermore, the permeation of materials through the membrane may be driven by the relative material concentrations, partial pressure and/or polarity differentials of the parts of gasses which are applied to sides of the membrane, parts of gasses being molecules, atoms or the like. Preferable at least one container wall is adapted to locate said membrane.

The scope of the invention is to control the atmosphere within a container in a sufficient and stable way.

It is not appropriate if it is necessary to design a specific membrane to use with each kind of perishable goods, such as fruit and/or vegetables. It is therefore preferable to design a single membrane, which membrane is capable of handling gas concentrations in the cargo region from as close to 0% carbon dioxide as possible to approximately 21% carbon dioxide and from of approximately 21% oxygen to as close to 0% oxygen as possible.

A membrane adapted to facilitate the transportation of different molecular species as parts of gasses contained in the atmosphere through the membrane at different rates. In a preferred embodiment of the invention a membrane is used, where a permeability of carbon dioxide is at least eight times higher than the permeability of oxygen.

In an other embodiment of the invention a membrane where the permeability of carbon dioxide is at least 9,5 times higher than the permeability of oxygen is used.

In an other embodiment of the invention a membrane where the permeability of carbon dioxide is at least 19 times higher than the permeability of oxygen is used.

In a further embodiment of the invention a membrane where the permeability of carbon dioxide is at least 3eight times higher than the permeability of oxygen is used.

In a further embodiment the first region and the second region are divided or separated by the membrane.

The combined proportions of carbon dioxide and oxygen in ambient air are about 21%. However, such a ratio or composition of carbon dioxide and oxygen often does not suit or provide an optimal environment for enhancing the shelf life of a lot of stored products.

In addition, during normal aerobic respiration quantities of oxygen will be used up and replaced by carbon dioxide (and increased levels of water vapor). In a closed environment, such as a sealed container, the shelf life of perishable goods have been shown to be negatively affected, that is fruit and vegetables stored in oxygen deficient environments for prolonged periods of time will deteriorate and/or rot. Such a phenomenon is considered to be the result of the onset of anaerobic respiration, the by-products of which are more carbon dioxide and also alcohols and acetaldehydes. These by-products may quickly accumulate to toxic levels causing browning and death of fruit and vegetable tissue. Accordingly, to prolong the shelf life of stored goods it is considered necessary to ensure the availability of optimal concentrations and/or volumes of oxygen within the container.

Therefore, as the levels of oxygen fall within the container the controller may be adapted to send an instruction to activate a valve (associated with bi-directional flow means, and inlet, or an outlet) to enable fresh air to flow into the container via an inlet. Conversely, as the fresh air is flowing into the container volumes of carbon dioxide may be evacuated from the container via an outlet located within same.

The flow means are represented by means provided to lead or transport a gas or a mixture of gasses, such as pipes, tubes, ducts, hoses, canals, leading or transporting gas or mixture of gasses (or ambient air) from one enclosure to another and/or from/to an enclosure to/from the ambient atmosphere.

Accordingly, to enhance the longevity of stored produce it becomes necessary to manipulate the composition of container gases such that ratio or sum proportions of carbon dioxide and oxygen differ from that of ambient air (that being approximately 21%).

Preferably the apparatus according to the invention may include only one membrane, but more than one membrane of the substantially same type can be used to increase the total membrane area. A membrane may be preferably located by at least one wall of a container and may be adapted to affix to the interior of a container so as to divide said container into at least two sections. For example, a membrane affixed to the side walls, the roof and the floor of a container may effectively divide the container into two compartments, a first compartment being located substantially near the front of the container, and a second compartment being located substantially near the rear or door end of the container.

In a further preferred embodiment the membrane may be located substantially near the rear of the container. In such an embodiment the gas buffer region may therefore be located near the rear of the container. Furthermore, such a membrane may be located to provide a void or buffering region around at least one bi-directional flow means which is adapted to control the flow of air into the buffer region (from outside the container) and the flow of gases out of the buffer region both into the storage compartment and completely out of the container

However, in alternative embodiments the gas permeable membrane may be located or positioned in any number of orientations with respect to the container and need not be located substantially near the rear of the container so as to divide the container into two compartments. For example, the gas permeable membrane may be shaped as a bag or box. By shaping the gas permeable membrane as a bag or box, the buffer region can be made as an independent or replaceable unit, which can be located on either the exterior or the interior of a container it can even be located on the exterior side as well as the interior side of a container. In alternative embodiments a container may include two, three or more membranes which may be positioned to divide the container into three, four or more regions. In addition, a membrane adapted for use with the present invention may be formed from any number or varieties of materials which exhibit gas or fluid permeable and/or selectively permeable characteristics. Those skilled in the art should appreciate that other locations for a permeable membrane and quantities and characteristics of a membrane are also envisioned and reference to the above only throughout this specification should in no way be seen as limiting.

Preferably the gas permeable membrane may be adapted to facilitate the flow of carbon dioxide from the cargo compartment of the container to the gas buffer region of the container. As discussed above, normal aerobic respiration requires the availability of oxygen and produces carbon dioxide as a waste product. The effective disposal of this waste product is essential as above specific threshold levels, high carbon dioxide concentrations in a container combined with low levels of oxygen may result metabolic imbalances in perishables that result in internal damage of the goods.

In a further preferred embodiment the membrane consists fully or partly of polymeric material. Such a membrane is suitable in an embodiment, where the buffer region is formed as a kind of cartridge. The cartridge eventually being changeable and can be placed inside the container or outside the container with the membrane exposed to either the ambient atmosphere or to the atmosphere in the cargo region.

Further the membrane can consist fully or partly of ceramic material or of a combination of ceramic and polymeric material.

However, at optimal levels the concentration carbon dioxide may serve as an inhibitor to respiratory activity of perishables. Furthermore, an optimal composition of carbon dioxide within a container, in combination with an optimal oxygen composition, may cause the perishables stored to exist in a near dormant state the consequence of which is natural ripening and allows crops to be harvested closer to ripeness or to be exposed to extended transportation periods.

The composition of carbon dioxide typically increases within the cargo region of the container (due to normal respiration of produce stored). Such carbon dioxide may therefore be adapted to flow through the permeable membrane from the cargo storage compartment into the gas buffer region, thereby reducing the volume of carbon dioxide within the cargo region.

The flow of carbon dioxide from the cargo region to the gas buffer region will continue as long as the concentration of carbon dioxide within the cargo region remains higher than that of the gas buffer region. Once the concentration of carbon dioxide within the cargo region equals that within the gas buffer region an equilibrium will be reached—that is, the flow of carbon dioxide through the permeable membrane will cease.

In a further preferred embodiment the gas permeable film may be adapted to facilitate the flow of oxygen from the gas buffer region of the container to the storage compartment of the container. In particular, the selectively permeable polymeric membrane may allow oxygen to flow through it, provided that the direction of such flow is opposite that of the carbon dioxide.

In a further preferred embodiment a sensor located within the container may be adapted to sense the concentrations and/or volumes of carbon dioxide within the cargo storage compartment of a container.

A sensor may be appropriately positioned to illicit the concentrations of carbon dioxide within the various regions of a container. In particular, a sensor may be able to detect or sense when carbon dioxide levels within the cargo region are at a level indicative of respiratory activity has taken place within the container. In such instances the sensor may send a signal (such as a digital or analogue signal, or a voltage or amplitude value) to the controller which is adapted to activate or deactivate a valve controlling a bi-directional flow means such that an outlet located in the gas buffer region may open, thereby evacuating the carbon dioxide from that region and allowing carbon dioxide to continue to flow through the membrane.

Preferably a bi-directional flow means located near the rear of the container may open to allow air to flow into the buffer region. In such instances there will be a reduction in the composition of carbon dioxide within buffer region and an increased oxygen concentration within same.

As volumes of carbon dioxide are produced in the cargo region and passed across the membrane into the buffer region (and then expunged out of the container via the bi-directional flow means) the pressure within the cargo region will be reduced as the volumes of both the oxygen and carbon dioxide diminish.

Accordingly, and in a further preferred embodiment the controller may activate or deactivate a valve controlling a bi-directional flow means to open an inlet so that air may flow into the cargo region of the container. As the oxygen concentration within the container diminishes (as a result of normal aerobic respiration) or as the pressure operating within the cargo region diminishes an inlet located within the cargo compartment of the container may be opened to supply a quantity of fresh air into the container.

The operation of such an inlet may be controlled by the controller which receives signals from a sensor adapted to sense the oxygen and/or carbon dioxide composition within a container.

Accordingly, by appropriately opening and closing container inlet(s) and outlet(s) the composition of gases within the container can be controlled. Such operation may be enabled using a controller and may be facilitated by a number of sensors which are adapted to detect the composition of gases within a container.

In addition, the provision of a selectively permeable membrane adapted to affix to the interior of the container will enable evacuation of carbon dioxide from the cargo region of the container into a gas buffer region. The gas buffer region can similarly be evacuated by operation of a bi-directional flow means operating as an outlet which may open and close to regulate the flow of air into the buffer region (from outside the container).

The invention in other aspect provides a method for controlling the composition of gases within a container, said container including a plurality of walls, and at least one inlet and/or outlet, with an apparatus including at least one sensor, at least one controller and at least one gas permeable membrane through which different parts of gasses at different rates can pass, a first region and a second region, the first region being for holding cargo and the second region defining a gas buffer region, said at least one inlet and/or outlet being in communication with said buffer region, the method comprising removing carbon dioxide from the first region by use of a membrane, and regulating of the composition of gases in the enclosure is done by mixing the gas composition in the gas buffer region with air from the ambient atmosphere.

In a further embodiment of the method the cargo region and the buffer region are divided or separated by the membrane.

The method further makes it possible to regulate and/or control the composition of gases in the enclosure by mixing the gas composition in the gas buffer region and/or the cargo region with air from the atmosphere is done by opening one or more valves to the ambient atmosphere.

Further it is possible to regulate and/or control the composition of gases in the enclosure by mixing the gas composition in the gas buffer region and/or the cargo region with a gas or a mixture of gasses from a supply source.

The gas or mixture of gasses can be used to flush the cargo region, the buffer region or both, after the perishables are positioned in the cargo region or a gas or a mixture of gases can be used to adjust the momentary gas composition within the cargo region, the buffer region or both.

In another embodiment of the method it is possible to regulate and/or control the composition of gases in the enclosure by at least one of the following characteristics
(i) measuring the content of carbon dioxide in the buffer region and if necessary mixing, diluting or replacing the gas in the buffer region and/or the cargo region with air from the outside atmosphere;
(ii) measuring the content of carbon dioxide in the cargo region and if necessary mixing, diluting or replacing the gas in the buffer region and/or the cargo region with air from the outside atmosphere;
(iii) measuring the content of oxygen in the buffer region and if necessary mixing, diluting or replacing the gas in the buffer region and/or the cargo region with air from the outside atmosphere;
(iv) measuring the content of oxygen in the cargo region and if necessary mixing, diluting or replacing the gas in the buffer region and/or the cargo region with air from the outside atmosphere.

The regulation according to the method is based on readings from one or more sensors as described above.

The present invention provides numerous advantages over the prior art control systems.

The provision of an effective yet cost efficient system adapted to regulate the composition of gases within a container is of advantage.

The ability of the present invention to be effectively integrated and installed into existing containers for a fraction of the cost of the prior art controlled atmosphere (CA) systems is of advantage.

A further advantage obtained by the present invention is the possibility of controlling the content of carbon dioxide in the cargo zone at lower concentrations of carbon dioxide and oxygen. This is achievable with the membrane and with the method as described above.

The method makes it possible to control the concentration of carbon dioxide, oxygen or both by “diluting” the gas in the buffer zone with air from the ambient atmosphere or by injecting a gas from a gas source.

The sensors giving readings about the condition or composition of the gas or atmosphere in the cargo—and/or buffer zone, which readings or impulses are used to activate one or more valves and/or pumps, vents, blowers, directly or after being processed by one or more processing units.

To achieve a membrane with sufficient surface area and with suitable physical dimensions, a preferred embodiment of the membrane is folded or pleated to achieve a surface area greater than the actual physical extension.

Hereby it is possible to maintain a great flow of volume (or flux) through the membrane at a relative small physical extension.

The flow of volume through the membrane is directly proportional with the area of the membrane.

A possible configuration of a suitable membrane comprises a primary layer attached to an intermediate layer which again is attached to a secondary layer. The primary layer is the selective layer determining the selectivity of the membrane. The intermediate layer preferably has a permeability which is higher than the permeability for the primary layer and most preferable with the same permeability as for the secondary layer. The secondary layer is preferably made of a porous material with a very high permeability.

The intermediate layer is applied in a thin layer (preferably thinner compared to the primary layer) to the secondary layer and is supposed to form a good adherence to the primary layer.

### BRIEF DESCRIPTION OF DRAWINGS

Further aspects of the present invention will become apparent from the following description which is given by way of example only and with reference to the accompanying drawings in which:

FIG. 1 shows a side view of an apparatus formed in accordance with a preferred embodiment,

FIG. 2 shows a container with a buffer region/zone located outside a container,

FIG. 3 shows a container with a buffer region/zone located inside a container and

FIG. 4 shows a schematic view of a preferred embodiment of a membrane for use in the apparatus according to the invention.

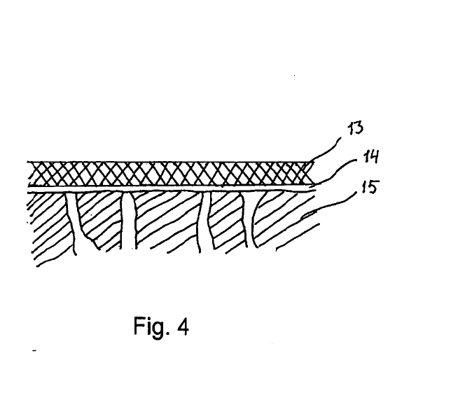

### BEST MODES FOR CARRYING OUT THE INVENTION

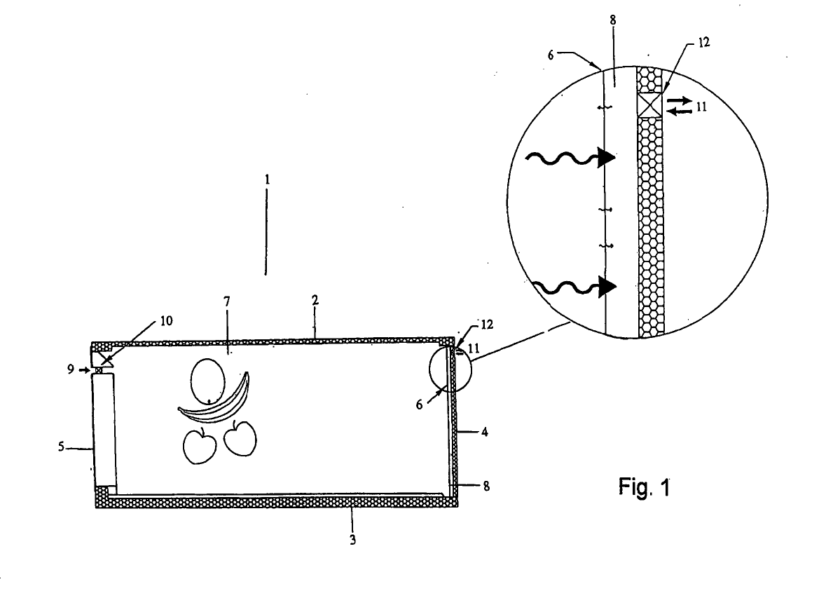

FIG. 1 shows a container 1 which has elements of a apparatus installed as configured in accordance with a preferred embodiment of the present invention. The container 1 includes a roof 2, floor 3, two side walls (not shown), rear wall 4 (formed as a door) and a front wall 5.

Also shown is membrane 6 which is formed as a gas permeable plastic film. The membrane 6 is adapted to affix to the side walls, roof 2 and floor 3 of the container 1 to divide the container 1 into a storage region 7 and gas buffer region 8. Membrane 6 is configured to have greater permeability to carbon dioxide than to other gases that exist within container 1 (for example, oxygen, nitrogen, ethylene).

Also shown is bi-directional flow means 9 which includes valve 10 and is adapted to open to facilitate gas flows into or out of the container air into the cargo region 7 of the container. In addition, bi-directional flow means 11 is shown which serves as an inlet and outlet and is adapted under the operation of valve 12 to facilitate the flow of air into and/or out of gas buffer region 8.

In the embodiment shown, as the composition of carbon dioxide within the storage area 7 rises (for example, as a result of normal respiration), volumes of the carbon dioxide produced are conveyed via the membrane 6 to gas buffer region 8. Membrane 6 operates as a selectively permeable membrane having a greater permeability to carbon dioxide than to other gases prevailing in the container 1.

In a preferred embodiment of the invention a membrane 6 is used, where a permeability of carbon dioxide is at least eight times higher than the permeability of oxygen.

In an other embodiment of the invention a membrane 6 where the permeability of carbon dioxide is at least 9,5 times higher than the permeability of oxygen is used.

In an other embodiment of the invention a membrane 6 where the permeability of carbon dioxide is at least 19 times higher than the permeability of oxygen is used.

In a further embodiment of the invention a membrane 6 where the permeability of carbon dioxide is at least 3eight times higher than the permeability of oxygen is used.

A possible configuration of a suitable membrane 6 comprises a primary layer 13 attached to an intermediate layer 14 which again is attached to a secondary layer 15. The primary layer 13 is the selective layer determining the selectivity of the membrane 6. The intermediate layer 14 preferably has a permeability which is higher than the permeability for the primary layer 13 and most preferable with the same permeability as for the secondary layer 15. The secondary layer 15 is made of a porous material with a very high permeability.

The intermediate layer 14 is applied in a thin layer (preferably thinner compared to the primary layer 13) to the secondary layer 15 and is supposed to form a good adherence to the primary layer 13.

Cargo storage region 7 also includes a sensor (not shown) which is adapted to poll the interior of the container to assess the composition of gases within the container. As the volume of oxygen decreases (as a result of normal aerobic respiration) within storage region 7 the sensor (not shown) will detect this occurrence and send an appropriate signal to a controller (not shown) which will activate or deactivate valve 10 to open flow means 9. By opening inlet 9 air will be supplied into the storage area 7, thereby increasing the oxygen content of same.

The composition of carbon dioxide typically increases within the storage region 7 of the container 1 due to normal respiration of perishables stored in the container. Such carbon dioxide will flow through the permeable membrane 6 into the gas buffer region 8, thereby reducing the volume and/or concentrations of carbon dioxide within the storage region 7.

Sensors appropriately located in the container are able to detect or sense when carbon dioxide levels within cargo region 7 and/or the gas buffer region 8 are at allowable levels. When the levels of carbon dioxide within the cargo region 7 and/or gas buffer region 8 become too high a sensor will send a signal to the controller to activate or deactivate valve 12 (associated with bi-directional flow means 11) to open which will facilitate the ingress of fresh air into the gas buffer region 8 as necessary and the evacuation of carbon dioxide from same.

As the concentration of carbon dioxide within the buffer region 8 falls below the concentration of carbon dioxide within the storage region 7 the flow of carbon dioxide from the storage region 7 through the permeable membrane 6 into the buffer region 8 will proceed, thereby reducing the composition of carbon dioxide within the storage region 7.

Therefore, use of the system in a container 1 will effectively manipulate the composition of gases within the container 1 such that the sum proportion of carbon dioxide and oxygen in the container may be varied from 21%. In particular the outgoing and/or ingoing air may be actively manipulated through the opening and/or closing of inlets and outlets which effectively control gas flows into and/or out of container 1 which facilitates the change in this sum proportion (of 21%) as necessary.

The system including the apparatus makes it possible to use a method for controlling the composition of gases within a container 1, said container 1 including a plurality of walls, and at least one inlet and/or outlet 11, with an apparatus including at least one sensor, at least one controller and at least one gas permeable membrane 6 through which different parts of gasses at different rates can pass, a first region 7 and a second region 8, the first region 7 being for holding cargo and the second 8 region defining a gas buffer region, said at least one inlet and/or outlet 11 being in communication with said buffer region 8, the method comprising removing carbon dioxide from the first region 7 by use of a membrane 6, and regulating of the composition of gases in the enclosure is done by mixing the gas composition in the gas buffer region 8 with air from the ambient atmosphere.

In a further embodiment of the method the first region 7 and the second region 8 is divided or separated by the membrane 6.

The method further makes it possible to regulate and/or control the composition of gases in the enclosure by mixing the gas composition in the gas buffer region 8 and/or the cargo region 7 with air from the atmosphere is done by opening one or more valves to the ambient atmosphere.

Further it is possible to regulate and/or control the composition of gases in the enclosure by mixing the gas composition in the gas buffer region and/or the cargo region with a gas or a mixture of gasses from a supply source.

In another embodiment of the method it is possible to regulate and/or control the composition of gases in the enclosure by at least one of the following characteristics
(i) measuring the content of carbon dioxide in the buffer region and if necessary mixing, diluting or replacing the gas in the buffer region and/or the cargo region with air from the outside atmosphere;
(ii) measuring the content of carbon dioxide in the cargo region and if necessary mixing, diluting or replacing the gas in the buffer region and/or the cargo region with air from the outside atmosphere;
(iii) measuring the content of oxygen in the buffer region and if necessary mixing, diluting or replacing the gas in the buffer region and/or the cargo region with air from the outside atmosphere;
(iv) measuring the content of oxygen in the cargo region and if necessary mixing, diluting or replacing the gas in the buffer region and/or the cargo region with air from the outside atmosphere.

In effect, the above system provides an improved control method which can actively monitor the composition of gases in container 1 and provide an environment which can be optimized for the storage of container content.

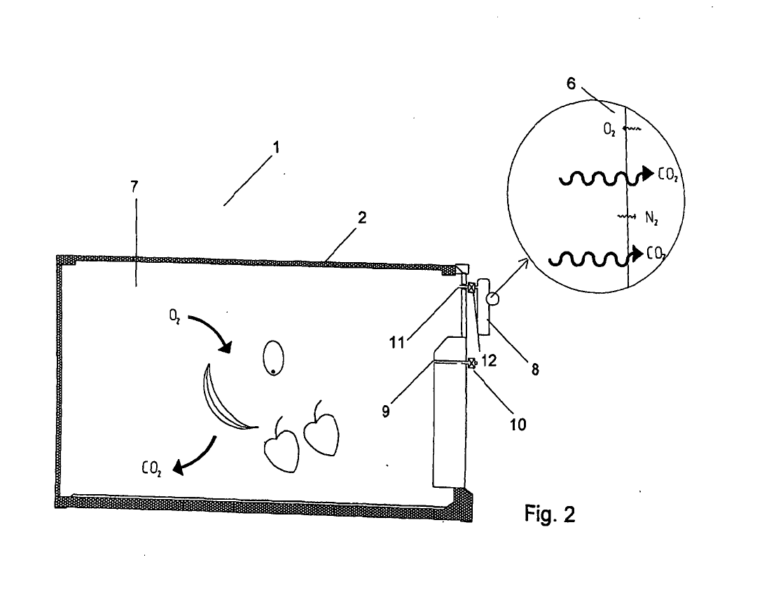

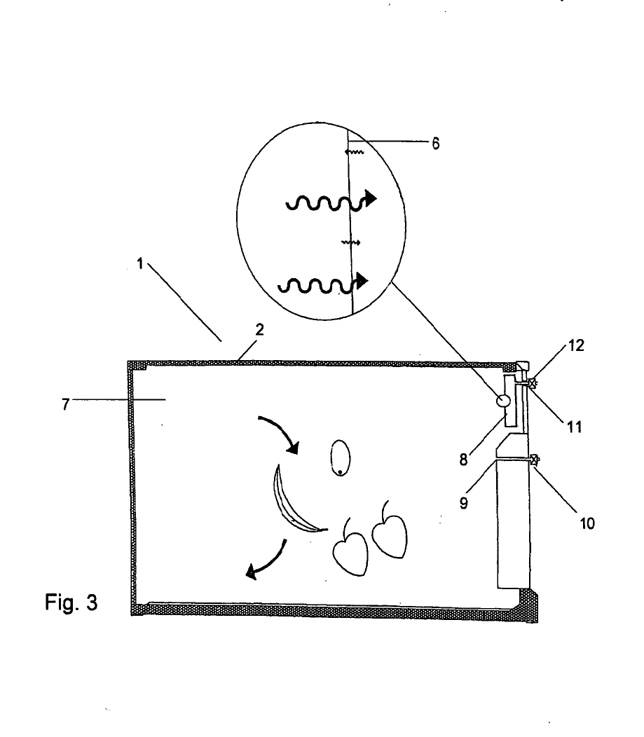

Referring to FIGS. 2 and 3, instead of having the membrane 6 adapted to affix to the side walls, roof and floor of the container as described with reference to FIG. 1, the apparatus is a replaceable unit comprising a buffer region 8 which includes a selectively permeable membrane 6 either situated inside the container as showed in FIG. 2 or outside the container as shown in FIG. 3.

Furthermore, the system is able to effectively control the flow of gases into and/or out of a container to thereby promote a gaseous atmosphere in a container which will prolong the shelf life of stored produce—wherein the system provided is both relatively inexpensive to produce and to maintain.

Aspects of the present invention have been described by way of example only and it should be appreciated that modifications and additions may be made thereto without departing from the scope thereof.

1. An apparatus for controlling the composition of gases within a container, said container including a plurality of walls, and at least one inlet and/or outlet, the apparatus including at least one sensor, at least one controller and at least one gas permeable membrane through which different parts of gasses at different rates can pass, the apparatus having a first region and a second region, the first region being for holding cargo and the second region defining a gas buffer region, said at least one inlet and/or outlet being in communication with said buffer region said membrane being adapted to allow oxygen and carbon dioxide to flow through it, provided that the direction of the flow of oxygen is opposite that of the carbon dioxide, wherein the membrane has a permeability for carbon dioxide, which is at least eight times higher than the permeability for oxygen.

2. An apparatus according to claim 1, wherein the membrane has a permeability for carbon dioxide, which is at least 9,5 times higher than the permeability for oxygen.

3. An apparatus according to claim 1, wherein the membrane has a permeability for carbon dioxide, which is at least 19 times higher than the permeability for oxygen.

4. An apparatus according to claim 1, wherein the membrane has a permeability for carbon dioxide, which is at least 3eight times higher than the permeability for oxygen.

5. An apparatus according to claim 1, which has at least one of following characteristics
(i) said membrane defines a gas buffer region located inside said container;
(ii) said membrane defines a gas buffer region located on the exterior of said container;
(iii) said membrane defines a gas buffer region located in a cartridge;
(iv) at least one gas buffer region placed between the cargo zone and the membrane, and with one side of the membrane exposed to ambient atmosphere;
(v) gas buffer regions defined by one or more membranes, arranged in parallel.
(vi) gas buffer regions defined by one or more membranes, arranged in series.

6. An apparatus according to claim 5, wherein at least one valve is adapted to open when activated or deactivated by the controller to provide a passage through which gases flow into and/or out of the container.

7. An apparatus according to claim 1, wherein said membrane is located to provide a void or buffering region around at least one bi-directional flow means which is adapted to control the flow of gas into the buffer region and the flow of gases out of the buffer region both into the storage compartment and completely out of the container.

8. An apparatus according to claim 1, wherein a sensor located within the container is adapted to sense the concentration and/or volumes of carbon dioxide and/or oxygen within the cargo storage compartment of a container.

9. An apparatus according to claim 1, comprising bi-directional flow means being able to open to allow gas to flow into the buffer region.

10. An apparatus according to claim 1, comprising bi-directional flow means being able to open an inlet so that gas may flow into the cargo region of the container.

11. An apparatus according to claim 1, comprising bi-directional flow means being able to open to allow gas to flow between the cargo region and the buffer region.

12. An apparatus according to claim 1, comprising bi-directional flow means being able to open an inlet so that gas may flow into the cargo region of the container.

13. An apparatus according to claim 1, comprising flow means providing the cargo region and/or the buffer region with a gas or a mixture of gasses from a supply source.

14. An apparatus according to claim 1, wherein the container is a building.

15. An apparatus according to claim 14 wherein the building is a cool store.

16. A method for controlling the composition of gases within a container, said container including a plurality of walls, and at least one inlet and/or outlet, with an apparatus including at least one sensor, at least one controller and at least one gas permeable membrane through which different parts of gasses at different rates can pass, a first region and a second region, the first region being for holding cargo and the second region defining a gas buffer region, said at least one inlet and/or outlet being in communication with said buffer region, the method comprising removing carbon dioxide from the first region by use of a membrane, wherein regulating the composition of gases in the enclosure is done by mixing the gas composition in the gas buffer region with air from the ambient atmosphere.

17. A method according to claim 16 wherein regulating the composition of gases in the enclosure by mixing the gas composition in the gas buffer region and/or the cargo region with air from the atmosphere is done by opening one or more valves to the ambient atmosphere.

18. A method according to claim 16 wherein regulating the composition of gases in the enclosure by mixing the gas composition in the gas buffer region and/or the cargo region with a gas or a mixture of gasses from a supply source.

19. A method according to claim 16, which has at least one of the following characteristics
(i) measuring the content of carbon dioxide in the buffer region and if necessary mixing, diluting or replacing the gas in the buffer region and/or the cargo region with air from the outside atmosphere;
(ii) measuring the content of carbon dioxide in the cargo region and if necessary mixing, diluting or replacing the gas in the buffer region and/or the cargo region with air from the outside atmosphere;
(iii) measuring the content of oxygen in the buffer region and if necessary mixing, diluting or replacing the gas in the buffer region and/or the cargo region with air from the outside atmosphere;
(iv) measuring the content of oxygen in the cargo region and if necessary mixing, diluting or replacing the gas in the buffer region and/or the cargo region with air from the outside atmosphere.
